(19) United States
(12) Patent Application Publication
(10) Pub. No.: US 2015/0268761 A1
(43) Pub. Date: Sep. 24, 2015

(54) CAPACITIVE TOUCH PANEL AND DISPLAY DEVICE

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventor: Shengji Yang, Beijing (CN)

(73) Assignee: BEJING BOE OPTOELECTRONICS TECHNOLOGY CO., LTD, Beining (CN)

(21) Appl. No.: 14/344,229

(22) PCT Filed: Aug. 1, 2013
(86) PCT No.: PCT/CN13/80658

§ 371 Date: Mar. 11, 2014

(30) Foreign Application Priority Data
Mar. 26, 2013 (CN) 201310099649.9

(51) Int. Cl. G06F 3/044; G06F 3/041

(52) U.S. Cl. CPC G06F 3/044; G06F 3/0412; G06F 2203/04101; G06F 2203/04104; G06F 2203/04111; G06F 2203/04112

(57) ABSTRACT

Embodiments of the present invention disclose a capacitive touch panel and a display device. Waterproof, overhanging and antijamming effects of capacitive touch panels are enhanced by adjusting patterns of sensing electrode units and drive electrode units. The capacitive touch panel of embodiments of the present invention includes at least one column of sensing electrode line and at least one row of driving electrode line, wherein the sensing electrode line comprises a plurality of sensing electrode units in which adjacent ones are bridged in series to each other and four outwardly projecting bumps are provided in said sensing electrode units; the driving electrode line comprises a plurality of drive electrode units in which adjacent ones are bridged in series and four inwardly recessed gaps are provided in the drive electrode units; the pattern of sensing electrode units and the pattern of drive electrode units are complementally matching and do not contact each other.

### TECHNICAL FIELD

Embodiments of the present invention relate to a capacitive touch panel and a display device.

### BACKGROUND

Touch panels win more and more attention as a bran-new kind of input devices due to their features of fast speed, convenience, and good human-computer interaction. Depending on their technical principles, touch panels are mainly classified into resistive touch panels and capacitive touch panels. Since resistive touch panels are limited by multi-point touch control, many manufacturers focus more on development and research of capacitive touch panels.

Capacitive touch panels may sense currents from human bodies. When a finger touches the metal layer, a coupled capacitance is formed between the user and the touch panel surface. For high frequency currents, a capacitor is a direct conductor, locations of touch points may be accurately calculated by detecting variations of output signals.

As shown in FIG. 1, capacitive touch panels in prior art commonly use diamond shaped ITO structure, that is, structures of both drive electrode units and sensing electrode units are of diamond structure. In order to avoid conduction among electrodes, various layers of ITOs are connected by bridging. FIG. 2 is the pattern of sensing electrode units and drive electrode units in one pixel unit. However, the inventor found out that there exist at least the following problems with capacitive touch panels in prior art. Since diamond structure electrodes are adopted, resistance value of laterally arranged drive electrodes tends to be substantially larger than that of longitudinally arranged sensing electrodes. In addition, since right opposite areas between electrodes are small, the coupling capacitance is formed small, resulting in poor performance of waterproof, overhanging and anti-jamming for capacitive touch panels in prior art.

### SUMMARY

Embodiments of the present invention provide a capacitive touch panel and a display device which enhance the capacitive touch panel's waterproof, overhanging and anti-jamming effects by adjusting patterns of sensing electrode units and drive electrode units.

In order to address the above-mentioned technology problems, embodiments of the present invention adopt the following technical solution.

A capacitive touch panel includes at least one column/row of sensing electrode line and at least one row/column of driving electrode line.

The sensing electrode line comprises a plurality of sensing electrode units in which adjacent ones are bridged in series to each other and four outwardly projecting bumps are provided in the sensing electrode units.

The driving electrode line comprises a plurality of driving electrode units in which adjacent ones are bridged in series and four inwardly recessed gaps are provided in the driving electrode units.

A pattern of the sensing electrode units and a pattern of said driving electrode units are complementally matching and do not contact each other.

Furthermore, said sensing electrode lines and said driving electrode lines are arranged alternatively and crossing each other.

Furthermore, said sensing electrode unit is of an axisymmetric structure about the sensing electrode line where the sensing electrode unit is located at; and said driving electrode unit is of an axisymmetric structure about the driving electrode line where the driving electrode unit is located at.

Furthermore, materials for said sensing electrode units and said driving electrode units are indium tin oxide ITO.

Furthermore, empty electrode patterns are disposed between the pattern of said sensing electrode units and the pattern of said driving electrode units.

Furthermore, a spacing between the pattern of said empty electrodes and the pattern of said sensing electrode units is the same as that between the pattern of said empty electrodes and the pattern of said driving electrode units.

Furthermore, at least an insulating shielding layer is disposed between said sensing electrode line and said driving electrode line.

A display device including any of the above-mentioned capacitive touch panels.

With the capacitive touch panel provided in embodiments of the present invention, four outwardly projecting bumps are provided in a sensing electrode unit, four inwardly recessed gaps are provided in a driving electrode unit, and the pattern of sensing electrode units and the pattern of driving electrode units are complementally matching and do not contact each other, which reduces resistance value of driving electrode units, increases the coupling capacitance of the capacitive touch panel, and enhances the waterproof, overhanging and jamming-proof performance of the capacitive touch panel. Furthermore, the present invention provides a display device including the above-mentioned touch panel which provides the advantages of the touch panel.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is the pattern of sensing electrode lines and driving electrode lines of touch panels in prior art;

FIG. 2 is the pattern of sensing electrode units and driving electrode units of a touch panel in one single pixel of prior art;

FIG. 3 is the pattern of sensing electrode lines and driving electrode lines of a touch panel according to one embodiment of the present invention;

FIG. 4 is the pattern of sensing electrode units and driving electrode units of a touch panel in one single pixel according to one embodiment of the present invention;

FIG. 5 is the pattern of sensing electrode units and driving electrode units of a touch panel in one single pixel according to one embodiment of the present invention;

FIG. 6 is a graph of output signals of a touch panel according to one embodiment of the present invention and a prior art touch panel.

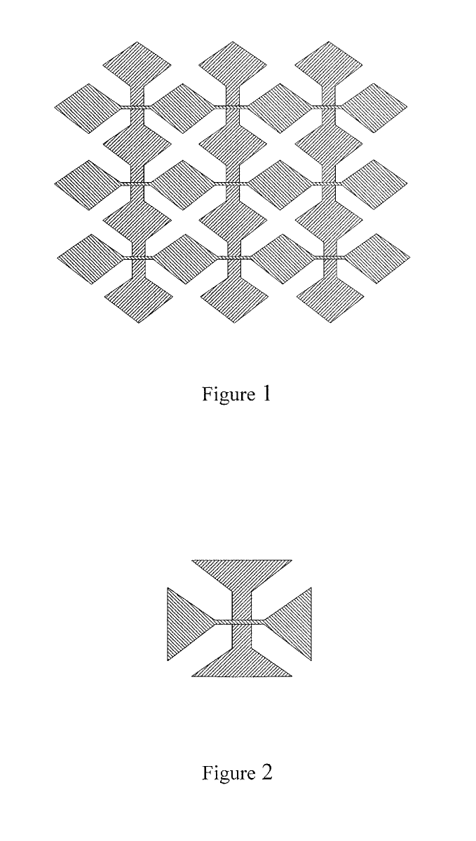

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

Unless otherwise defined, all the technical and scientific terms used herein have the same meanings as commonly understood by one of ordinary skill in the art to which the present invention belongs. The terms “first,” “second,” etc., which are used in the description and the claims of the present application for invention, are not intended to indicate any sequence, amount or importance, but distinguish various components. Also, the terms such as “a,” “an,” etc., are not intended to limit the amount, but indicate the existence of at lease one. The terms “comprises,” “comprising,” “includes,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

Embodiments of the present invention provide a capacitive touch panel that enhances waterproof, overhanging and jamming-proof effects of the capacitive touch panel by adjusting patterns of sensing electrode units and driving electrode units.

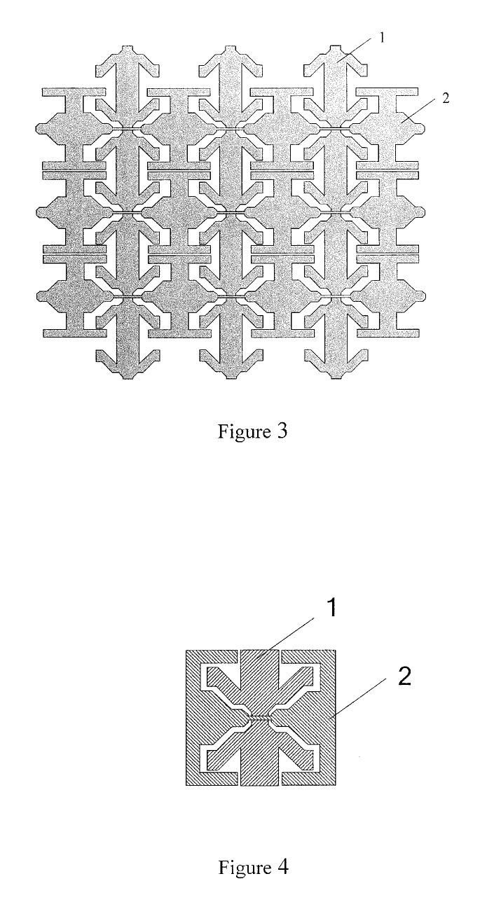

As shown in FIG. 3, an embodiment of the present invention provides a capacitive touch panel including at least one column of sensing electrode line and at least one row of driving electrode line. One skilled in the art should appreciate that “row” and “column” may be interchangeable, namely, the capacitive touch panel provided in this embodiment may also include at least one row of sensing electrode line and at least one column of driving electrode line. A sensing electrode line includes a plurality of sensing electrode units 1 in which adjacent ones are bridged in series to each other and four outwardly projecting bumps are provided in the sensing electrode units 1. A driving electrode line includes a plurality of driving electrode units 2 in which adjacent ones are bridged in series and four inwardly recessed gaps are provided in the driving electrode units 2. The pattern of sensing electrode units 1 and the pattern of driving electrode units 2 are complementally matching and do not contact each other.

As shown in FIG. 4, that shows the pattern of sensing electrode units 1 and driving electrode units 2 in one pixel unit, a sensing electrode unit 1 is provided with four outwardly projecting bumps and adjacent sensing electrode units are bridged in series. In practice, the bumps may be of various possible shapes such as sharp corner, round corner, semi-circle, and parallelogram. Therefore, there are various possibilities for the pattern of sensing electrode units. In addition, in order to achieve advantages such as esthetic appearance, convenience of calculating resistance value, it is also possible to adjust the shape of bumps to endow the pattern of sensing electrode units with high symmetry. For example, the sensing electrode units are formed into an axisymmetrical pattern. Of course, the sensing electrode units may also be formed into other nonaxisymmetrical patterns. On the other hand, a driving electrode unit 2 is provided with four inwardly recessed gaps in which adjacent driving electrode units 2 are bridged in series. The pattern of sensing electrode units 1 and the pattern of driving electrode units 2 are complementally matching to together form an ITO pattern in one pixel unit. Therefore, there are various possible instances for gap patterns of the driving electrode units and there are various possible instances for the pattern formed by driving electrode units, which will not be described here. In addition, patterns of sensing electrode units and driving electrode units do not contact each other, which guarantees no electrical connection due to contact occurs between sensing electrode units and driving electrode units, keeping sensing electrode units and driving electrode units being insulated.

Furthermore, sensing electrode lines and driving electrode lines are arranged alternatively and crossing each other. As shown in FIG. 3, the capacitive touch panel shown in FIG. 3 contains three columns of sensing electrode lines and three rows of driving electrode lines that are arranged in a mutually crossing and alternative manner to form together the pattern of ITO electrodes in the capacitive touch panel.

Furthermore, a sensing electrode unit is of an axisymmetric structure about the sensing electrode line where the sensing electrode unit is located at; and a driving electrode unit is of an axisymmetric structure about the driving electrode line where the driving electrode unit is located at. For example, as shown in FIG. 3, taking the second column of sensing electrode line from the left as an example, the sensing electrode units in the second column of sensing electrode line is of an axisymmetric structure about the second sensing electrode line.

Furthermore, materials for sensing electrode units and driving electrode units are indium tin oxide ITO.

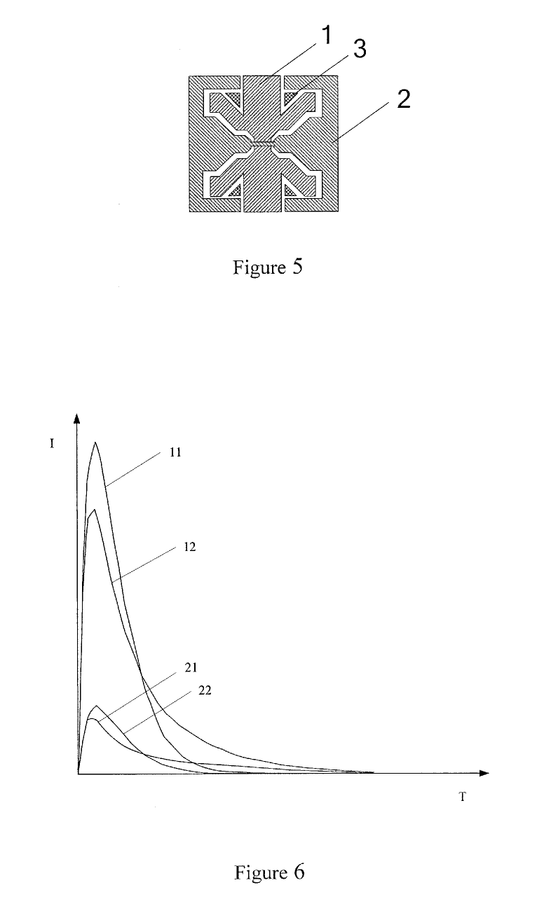

Furthermore, empty electrode patterns are disposed between the pattern of sensing electrode units and the pattern of driving electrode units. As shown in FIG. 5, empty electrodes 3 are disposed in gaps between sensing electrode units 1 and driving electrode units 2. Empty electrodes are provided in order to fill up gaps that possibly appear while sensing electrode units and driving electrode units form the ITO pattern so as to prevent visually apparent non-uniformity of the capacitive touch panel due to gaps. Apparently, there may also be many possibilities for the pattern of empty electrodes, which will not be described in detail here.

Furthermore, a spacing between the pattern of empty electrodes and the pattern of sensing electrode units is the same as that between the pattern of empty electrodes and the pattern of driving electrode units.

Furthermore, at least an insulating shielding layer is disposed between said sensing electrode line and said driving electrode line.

With the capacitive touch panel provided in the embodiment of the present invention, four outwardly projecting bumps are provided in a sensing electrode unit, four inwardly recessed gaps are provided in a driving electrode unit, and the pattern of sensing electrode units and the pattern of driving electrode units are complementally matching and do not contact each other, which reduces resistance value of driving electrode units, increases the coupling capacitance of the capacitive touch panel, and enhances the capacitive touch panel's waterproof, overhanging and jamming-proof effects.

In order for those skilled in the art to better understand the technical solution of the capacitive touch panel provided in embodiments of the present invention and the beneficial effects by the technical solution, the capacitive touch panel provided in the present invention will be explained in detail below with respect to specific embodiments.

First of all, taking one pixel unit shown in FIG. 4 as an example, resistance values of sensing electrode units and driving electrode units are estimated. As shown in FIG. 4, the size of a pixel unit is 5.75 mm×5.75 mm, a spacing between a sensing electrode unit and a driving electrode unit is 30 um, materials for sensing electrode units and driving electrode units are both indium tin metal oxide ITO, a thickness of the ITO film layer is 500 Å, a surface resistivity of ITO is 52Ω, and adjacent driving electrode units are connected in series by a metal bridge, wherein a thickness of the metal bridge film layer is 2200 Å and a surface resistivity of the metal bridge is 0.55Ω. With the above-mentioned reference conditions, resistance values of sensing electrode units and driving electrode units in a pixel unit of the embodiment of the present invention are estimated. Here a trigonometric integral method may be used in which resistance value of the ITO electrode is calculated by dividing the ITO electrode into several triangle ITO electrode blocks and using an integral method.

By means of the trigonometric integral method, under the above-mentioned reference conditions, the resistance value of sensing electrode units in the embodiment of the present invention is estimated to be 233.70Ω, and the resistance value of driving electrode units is estimated to be 370.86Ω. Similarly, with the same method and the same reference conditions, the resistance value of sensing electrode units in prior art is estimated to be 233.47Ω and the resistance value of driving electrode units in prior art is estimated to be 829.67Ω. It is evident that embodiments of the present invention reduce resistance value of driving electrode units by adjusting patterns of sensing electrode units and driving electrode units while keeping the resistance value of sensing electrode units constant. It is noted that the resistance value of sensing electrode line=the resistance of sensing electrode unit*the numbers of sensing electrode units, and the resistance value of driving electrode line=the resistance of driving electrode unit*the number of driving electrode units. Therefore, the estimated resistance values of sensing electrode units and driving electrode units may be further used to learn resistance characteristics of sensing electrode lines and driving electrode lines.

On the other hand, taking the touch panel shown in FIG. 3 as an example, the capacitance value of the sensing electrode line is estimated. As shown in FIG. 3, the capacitive touch panel includes three columns of sensing electrode lines and three rows of driving electrode lines. The size of a single pixel unit is 5.75 mm×5.75 mm, a spacing between a sensing electrode unit and a driving electrode unit is 30 um, materials for sensing electrode units and driving electrode units are both indium tin metal oxide ITO, a thickness of the ITO film layer is 500 Å, a thickness of the metal bridge film layer is 2200 Å, a thickness of the insulating layer between sensing electrode units and driving electrode units is 2000 Å and a dielectric constant ε=6.5 F/m.

As shown in FIG. 3, taking the second sensing electrode line from left as an example, this sensing electrode line couples in a divergence way with the first sensing electrode line from left, the third sensing electrode line from left and the driving electrode line to generated a coupling capacitance, therefore the coupling capacitance is mainly influenced by the right opposite area between sensing electrode units and driving electrode units. Under the above-mentioned reference conditions, the capacitance value of the second sensing electrode line from left is estimated to be 7.54 pf. Similarly, with the same reference conditions, the capacitance value of a sensing electrode line in prior art is estimated to be about 1.33 pf. Obviously, embodiments of the present invention increase right opposite area between sensing electrode units and driving electrode units and thus increase the coupling capacitance value of a touch panel by adjusting patterns of sensing electrode units and driving electrode units.

As compared with a touch panel in prior art, in a touch panel of embodiments of the present invention, the coupling capacitance value is increased and the resistance of driving electrodes is reduced. Therefore, when inputting identical voltage signals, the input signal curve may be as shown in FIG. 6, wherein the abscissa axis denotes time and the ordinate axis denotes output current intensity. Curve 11 shows the output signal of the touch panel of the embodiment of the present invention without finger's touch. Curve 12 shows the output signal of the touch panel of the embodiment of the present invention with a finger's touch. Curve 21 is the output signal of a touch panel in prior art without finger's touch. Curve 22 is the output signal of a touch panel in prior art with a finger's touch. It can be seen by comparison that the touch panel of embodiments of the present invention has a higher output signal peak value, that is, the SNR of the touch panel of embodiments of the present invention is higher for the same input. Furthermore, with respect to the output signal attenuation, the decay rate of output signal of the touch panel of the embodiments of the present invention is also faster than that of the touch panel of prior art. Therefore it can be seen that the touch panel of embodiments of the present invention has a better signal capture effect and a better anti-jamming effect. In addition, since the coupling capacitance of the touch panel in embodiments of the present invention is increased, the capacitance change ratio of the touch panel of embodiments of the present invention due to a water drop is smaller. Therefore, the touch panel of embodiments of the present invention has a better waterproof and anti-overhanging effects.

With the capacitive touch panel provided in embodiments of the present invention, four outwardly projecting bumps are provided in a sensing electrode unit, four inwardly recessed gaps are provided in a driving electrode unit, and the pattern of sensing electrode units and the pattern of driving electrode units are complementally matching and do not contact each other, which reduces resistance value of driving electrode units, increases the coupling capacitance of the capacitive touch panel, and enhances the capacitive touch panel's waterproof, overhanging and jamming-proof effects.

Furthermore, the embodiment of the present invention provides a display device including the touch panel according to the above-mentioned embodiments which has all advantages of said touch panel.

What have been described are merely specific implementations of the present invention, the scope of protection of the present invention is not limited thereto. Changes or alternatives that easily occur to any one skilled in the art within the technical scope disclosed by the present invention should be covered in the protection scope of the present invention. Therefore, the protection scope of the present invention should be based on the protection scope of the claims.

1. A capacitive touch panel comprising at least one column/row of sensing electrode line and at least one row/column of driving electrode line, wherein
said sensing electrode line comprises a plurality of sensing electrode units in which adjacent sensing electrode units are bridged in series and four outwardly projecting bumps are provided in said sensing electrode units;
said driving electrode line comprises a plurality of driving electrode units in which adjacent driving electrode units are bridged in series and four inwardly recessed gaps are provided in said driving electrode units;
a pattern of said sensing electrode units and a pattern of said driving electrode units are complementally matching and do not contact each other.

2. The capacitive touch panel of claim 1, wherein said sensing electrode lines and said driving electrode lines are arranged alternatively and crossing each other.

3. The capacitive touch panel of claim 1, wherein said sensing electrode unit is of an axisymmetric structure about the sensing electrode line where the sensing electrode unit is located at; and said driving electrode unit is of an axisymmetric structure about the driving electrode line where the driving electrode unit is located at.

4. The capacitive touch panel of claim 1, wherein materials for said sensing electrode units and said driving electrode units are indium tin oxide (ITO).

5. The capacitive touch panel of claim 1, wherein empty electrode patterns are disposed between the pattern of said sensing electrode units and the pattern of said driving electrode units.

6. The capacitive touch panel of claim 5, wherein a spacing between the pattern of said empty electrodes and the pattern of said sensing electrode units is the same as that between the pattern of said empty electrodes and the pattern of said driving electrode units.

7. The capacitive touch panel of claim 1, wherein at least an insulating shielding layer is disposed between said sensing electrode line and said driving electrode line.

8. A display device comprising the capacitive touch panel according to claim 1.
